(19) United States
(12) Patent Application Publication
(10) Pub. No.: US 2020/0184454 A1
(43) Pub. Date: Jun. 11, 2020

(54) Beacon-Based Identification System and Method

(71) Applicant: Vibes Media LLC, Chicago, IL (US)

(72) Inventors: Alexander Gates Campbell, Chicago, IL (US); John Haro, Chicago, IL (US)

(21) Appl. No.: 16/792,508

(22) Filed: Feb. 17, 2020

Related U.S. Application Data
(63) Continuation of application No. 14/708,936, filed on May 11, 2015.
(60) Provisional application No. 61/991,226, filed on May 9, 2014.
(60) Provisional application No. 61/991,234, filed on May 9, 2014.

(51) Int. Cl. G06Q 20/32; G06Q 10/10; G06Q 30/02; G06Q 20/40; G06Q 30/00; H04W 4/80; H04L 29/08

(52) U.S. Cl. CPC G06Q 20/327; G06Q 10/1095; G06Q 30/0282; H04W 4/23; G06Q 30/0185; H04W 4/80; H04L 67/306; G06Q 20/4014

(57) ABSTRACT

A system and method for exchanging information utilizes digital marketing devices, such as passes, to transmit and receive identifying information. The identifying information, which may be specific or general, can be used to assist users in identifying each other, relaying preferences or better assist others by providing easy access to preferences, historical data or the like.

### CROSS-REFERENCE TO RELATED APPLICATIONS

This application is a Continuation of U.S. application Ser. No. 14/708,936, titled “Beacon-Based Identification System and Method” and filed on May 11, 2015, which claims the benefit of U.S. Provisional Application Ser. Nos. 61/991,226 and 61/991,234 each filed on May 9, 2014, the disclosures of which are hereby incorporated by reference in their entirety.

### TECHNICAL FIELD OF THE INVENTION

The present invention relates to beacon-based identification systems and methods. The present invention relates more particularly to authenticating individuals based on applications and broadcast beacons provided on mobile electronic devices.

### BACKGROUND OF THE INVENTION

Mobile computing devices, such as smartphones, tablets, PDAs, portable media players and the like, as well as wearable technology such as smart watches, fitness monitors, smart glasses and the like, typically include applications or programs tailored to particular uses. These devices also typically have hardware and software usable to communicate over one or more wireless communication protocols such as, for example, cellular telephone protocols, Bluetooth, Bluetooth LE, WiFi, and the like.

Various applications or programs can access the hardware and software associated with one or more wireless communication protocol and thus communicate with other mobile computing devices or stand-alone devices that are running compatible applications or programs. Additionally, various sensors can interact with mobile computing devices and exchange information to and from the mobile computing device. For example, iBeacons available from StickNFind Technologies of Uniondale, N.Y. and the Mobile to Mortar™ iBeacon platform available from inMarket Media, LLC of Venice, Calif. each transmit information that is receivable by portable computing devices such as smartphones.

### SUMMARY OF THE INVENTION

There is disclosed herein a system and method for electronically confirming the identity of a person to at least one second person using portable electronic devices. The disclosed systems and method avoid disadvantages of prior devices while affording additional structural and operating advantages.

Generally speaking, the disclosed method for electronically confirming an identity of a first person to at least one second person comprises storing, on a remote server, electronic information related to an identity of a first person; continuously transmitting an information signal from a first transceiver within a first portable electronic device controlled by the first person, wherein the information signal includes at least a portion of the electronic information related to an identity of a first person stored on the remote server; receiving the electronic information from the remote server on a second portable electronic device controlled by a second person, wherein the second portable electronic device includes a second transceiver and a proximity sensor for determining when the first portable electronic device is a desired distance from the second portable electronic device; receiving the information signal from the first transceiver of the first portable electronic device on the second portable device; using the second portable electronic device to compare the information signal from the first transceiver of the first portable electronic device to the electronic information from the remote server to confirm the identity of the first person; and prompting the second portable electronic device when the first portable electronic device is a desired distance from the second portable electronic device.

Various types of mobile computing devices include software or programs that listen for signals received from various types of sensors. For example, various types of smartphones include mobile wallets that store electronic passes (e.g., coupons, sales flyers, loyalty cards, gift cards, event tickets, boarding passes and other digital marketing devices). These passes and mobile wallets have the ability to listen for signals received from sensors (e.g., beacons) to provide relevant information to the end user.

With proper programming, an application, program or pass can also be designed to generate or send a signal similar to a signal sent from a beacon. Such signals may include, for example, a unique identification number, sequence, code, other information or the like.

Generally speaking, the disclosed system for electronically confirming an identity of a first individual to a second individual comprises a remote server having stored thereon electronic information related to an identity of the first individual; a first portable electronic device having a first transceiver capable of continuously transmitting an information signal including at least a portion of the electronic information stored on the remote server; a second portable electronic device communicatively unknown to the first portable electronic device, the second portable electronic device having: a second transceiver which is operatively connected to the remote server to initially receive the electronic information; configured to continuously listen for electronic signals; and, capable of receiving the information signal from the first transceiver; wherein the second portable device receives the information signal and compares the information signal to the electronic information from the remote server; and a proximity sensor for determining when the first portable electronic device is a desired distance from the second portable electronic device, wherein, at least one of either the remote server, the first transceiver or the second transceiver is configured to prompt the second portable electronic device for a response when the proximity sensor determines that the first portable electronic device is the desired distance from the first portable electronic device.

### BRIEF DESCRIPTION OF THE DRAWINGS

For the purpose of facilitating an understanding of the subject matter sought to be protected, there are illustrated in the accompanying drawing, embodiments thereof, from an inspection of which, when considered in connection with the following description, the subject matter sought to be protected, its construction and operation, and many of its advantages should be readily understood and appreciated.

FIG. 1 is a schematic representation of an exemplary embodiment of an identification system according to this invention.

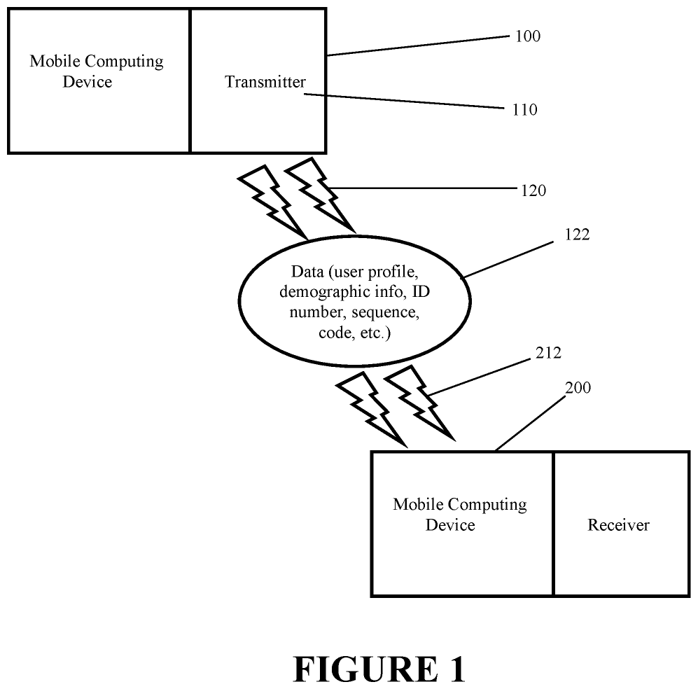

### DETAILED DESCRIPTION OF THE PREFERRED EMBODIMENTS

In an exemplary embodiment of an identification system a program, application or pass on a first mobile computing device 100 interacts with hardware and software 110 associated with one or more wireless communication protocols to send a wireless signal 120 from the first mobile computing device 100. The wireless signal is comprised of informational data 122 which may include, for example, user profile information, user demographic information, a unique identification number, sequence, code, or other similar information.

In various exemplary embodiments, a program, application or pass on a second mobile computing device 200 listens for, receives or interacts with a wireless signal 212. In such exemplary embodiments, various types of information can be received from the first mobile computing device depending on the desired use of the system.

For example, in an exemplary retail method of use, the first mobile computing device 100 may be used by a retail shopper while the second mobile computing device 200 may be used by a retail employee. In such exemplary embodiments, the information 122 sent over the wireless signal 120 may include, for example, profile information such as the shopper's name or age; demographic information such as the shopper's general or specific address or home location; previous shopping information or demographic information such as shopping trends or interests; questions submitted by the shopper; or a list of items the shopper is interested in viewing or purchasing. Upon receiving the information 122, the retail employee can better address concerns of the shopper or provide more relevant information regarding potential shopping choices.

For example, if the wireless signal 120 includes information regarding the brand and operating system of the shopper's cellular phone and the shopper is currently browsing cellular phone cases, the employee can suggest cases that are compatible with the cellular phone used by the shopper. Likewise, if the wireless signal 120 includes shopping information regarding previous purchases that indicates that the shopper frequently purchases so-called “cutting edge” or “bleeding edge” technology, the employee may suggest that the shopper consider a new “cutting edge” or “bleeding edge” device. Conversely, if the previous shopping history indicates that the shopper is unlikely to buy technology during its infancy stages, the employee may suggest that the shopper consider options that are in their second or further iterations.

In an exemplary home-service embodiment, the first mobile computing device 100 may be used by a service technician, installer, delivery personnel or other individual who arrives at an end user's house for home-service. In various ones of these exemplary embodiments, the second mobile computing device 200 is used by an end user who has requested or is otherwise receiving the home-service. In such exemplary embodiments, the home service person's mobile device may be turned into a beacon and made to broadcast a unique identification number, sequence, code or the like that positively identifies the service technician or like individual. In various ones of these exemplary embodiments the end user's mobile device may be programmed to receive the authentication number, sequence, code or the like in advance of the scheduled visit by the service technician or the like. In such exemplary embodiments, a positive correlation between the authentication number, sequence, code or the like and the identification number, sequence, code or the like positively identifies the individual carrying the first mobile computing device as the expected service technician or the like. The end users' mobile device then correctly and securely verifies that the home service person is in fact genuine. In various ones of these exemplary embodiments, the authentication number, sequence, code or the like may contain or correlate to identifying information such as a name or photograph. In such exemplary embodiments, the authentication number, sequence, code or the like may be received by the end user's mobile device and sent to a remote server to access further information, such as, for example a photograph of the technician, installed, delivery personnel or other individual to assist in positively identifying the individual.

In various exemplary embodiments, the end user's mobile device continually looks for the service person's device. When it does not find the device, it asks the end user if the service person has left and completed their work. It various exemplary embodiments, the end user's mobile device also sends a message alerting the home service person's company that the service person has left the job.

In various exemplary embodiments, once the home service person has performed their duty, the end user is presented with the option to pay for the service visit.

In various exemplary embodiments, once the home service person has performed their duty, the end user is presented with the option to set up a future service visit.

In various exemplary embodiments, once the home service person has performed their duty, the end user is asked to rate the performance of the home service person.

In an exemplary referral embodiment, the first and second mobile computing devices are used by two individuals who have been referred to each other but have not previously met and thus cannot positively identify each other (e.g., a blind date or new business associate). Upon receiving an appropriate identifying number, sequence, code or the like from the other user, each user can positively identify the other as the referred individual. It should be appreciated that an appropriate correlation may be made by exchanging identifying numbers sequences, codes or the like in advance of meeting or by sending identifying information, such as names, over the wireless signal. In various exemplary embodiments, the exchanged identifying number, sequence, code or the like may contain or correlate to further identifying information, such as a photograph stored on a remote server.

In an exemplary embodiment of a loyalty program, the application, program, or pass may send identifying information, such as a generic user ID number, a user name, or an identification number, sequence, code or the like, when a user visits a retail store. The retail store may track the number or frequency of visits by the user and provide various incentives for frequent visits or for visiting a desired number of times, such as, for example, providing a free or discounted item on each tenth visit or a discount for the top ten visiting users.

What is claimed is:

1. A method for electronically confirming an identity of a first person to at least one second person, the method comprising:
storing, on a remote server, electronic information related to an identity of a first person;
continuously transmitting an information signal from a first transceiver within a first portable electronic device controlled by the first person, wherein the information signal includes at least a portion of the electronic information related to an identity of a first person stored on the remote server;
receiving the electronic information from the remote server on a second portable electronic device controlled by a second person, wherein the second portable electronic device includes a second transceiver and a proximity sensor for determining when the first portable electronic device is a desired distance from the second portable electronic device;
receiving the information signal from the first transceiver of the first portable electronic device on the second portable device;
using the second portable electronic device to compare the information signal from the first transceiver of the first portable electronic device to the electronic information from the remote server to confirm the identity of the first person; and
prompting the second portable electronic device when the first portable electronic device is a desired distance from the second portable electronic device.

2. The method of claim 1, wherein prompting the second portable electronic device comprises a request to pay for a service provided by the first person.

3. The method of claim 1, wherein the first person is a customer of a retail store and the at least one second person is an employee of the retail store.

4. The method of claim 1, wherein the first person comprises a service technician and the second person comprises a customer hiring the service technician.

5. The method of claim 4, wherein prompting the second portable electronic device comprises a request to rate the service technician.

6. The method of claim 5, wherein prompting the second portable electronic device further comprises a request to schedule a follow-up appointment.

7. The method of claim 4, wherein the electronic information initially received by the second electronic device from the remote server provides access to a user profile.

8. The method of claim 7, wherein the user profile contains a photograph of the service technician that can be viewed on the second portable electronic device.

9. The method of claim 1, wherein the second transceiver is capable of transmitting a second information signal, the first transceiver is capable of receiving the second information signal, and the second information signal includes additional information relevant to at least one of either the first user and the second user.

10. A system for electronically confirming an identity of a first individual to a second individual, the system comprising:
a remote server having stored thereon electronic information related to an identity of the first individual;
a first portable electronic device having a first transceiver capable of continuously transmitting an information signal including at least a portion of the electronic information stored on the remote server;
a second portable electronic device communicatively unknown to the first portable electronic device, the second portable electronic device having:
a second transceiver which is:
operatively connected to the remote server to initially receive the electronic information;
configured to continuously listen for electronic signals; and,
capable of receiving the information signal from the first transceiver;
wherein the second portable device receives the information signal and compares the information signal to the electronic information from the remote server; and
a proximity sensor for determining when the first portable electronic device is a desired distance from the second portable electronic device;
wherein, at least one of either the remote server, the first transceiver or the second transceiver is configured to prompt the second portable electronic device for a response when the proximity sensor determines that the first portable electronic device is the desired distance from the first portable electronic device.

11. The system of claim 10, wherein the first user is a customer of a retail store and the second user is an employee of the retail store.

12. The system of claim 11, further comprising a remote server, wherein the identifying information relates to a user profile for the customer maintained on the remote server.

13. The system of claim 10, wherein the first user is a customer and the second user is a service technician.

14. The system of claim 13, wherein the remote server stores a user profile for the service technician.

15. The system of claim 14, wherein the identifying information provides access to the user profile to the customer.

16. The system of claim 15, wherein the user profile contains a photograph of the service technician that can be viewed by the customer on the second portable electronic device.

17. The system of claim 10, wherein the second portable electronic device is capable of determining when the first portable electronic device has moved a given distance away from the second portable electronic device.

18. The system of claim 17, wherein the second portable electronic device is capable of prompting the customer to pay for a service provided by the technician when the first portable electronic device moves the given distance away from the second portable electronic device.

19. The system of claim 17, wherein the second portable electronic device is capable of prompting the customer to rate the technician when the first portable electronic device moves the given distance away from the second portable electronic device.

20. The system of claim 17, wherein the second portable electronic device is capable of prompting the customer to schedule a follow-up appointment when the first portable electronic device moves the given distance away from the second portable electronic device.

21. The system of claim 10, wherein the first user and the second user are schedule to meet with each other but are not familiar with each other.

22. The system of claim 21, wherein the identifying information contains profile information about the first user that can be accessed by the second user to help identify the first user.

23. The system of claim 10, wherein the first transmitter is a first transceiver and the first receiver is a second transceiver;
wherein the second transceiver is capable of transmitting a second set of identifying information;
wherein the first transceiver is capable of receiving the second set of identifying information; and
wherein the second set of identifying information contains further information relevant to the interaction between the first user and the second user.
